(19) United States
(12) Patent Application Publication
(10) Pub. No.: US 2025/0096303 A1
(43) Pub. Date: Mar. 20, 2025

(54) Method of Manufacturing Power Storage Cell

(71) Applicant: TOYOTA JIDOSHA KABUSHIKI KAISHA, Toyota-shi Aichi-ken (JP)

(72) Inventors: Kazuhito KATO, Toyota-shi Aichi-ken (JP); Junta TAKASU, Nagoya-shi Aichi-ken (JP); Atsushi YAMANAKA, Nagoya-shi Aichi-ken (JP); Masato ONO, Nagoya-shi Aichi-ken (JP); Satoshi MORIYAMA, Nagoya-shi Aichi-ken (JP); Kosuke SUZUKI, Toyota-shi Aichi-ken (JP); Kazuki SUGIE, Miyoshi-shi Aichi-ken (JP); Kazuya KUMAZAWA, Nagoya-shi Aichi-ken (JP)

(73) Assignee: TOYOTA JIDOSHA KABUSHIKI KAISHA, Toyota-shi Aichi-ken (JP)

(21) Appl. No.: 18/883,411

(22) Filed: Sep. 12, 2024

(30) Foreign Application Priority Data
Sep. 20, 2023 (JP) 2023-152119

(51) Int. Cl. H01M 10/04

(52) U.S. Cl. CPC H01M 10/049; H01M 10/0431

(57) ABSTRACT

A method of manufacturing a power storage cell includes: forming a wound electrode assembly by winding a positive electrode, a negative electrode, and a separator; fixing a winding end portion, in a winding direction, of the wound electrode assembly, by a fixing member; housing, in a cell case, the wound electrode assembly having the winding end portion fixed by the fixing member; injecting an electrolyte solution in the cell case; and releasing fixing of the winding end portion by the fixing member, after the wound electrode assembly is housed in the cell case and the electrolyte solution is injected in the cell case.

### CROSS REFERENCE TO RELATED APPLICATIONS

This nonprovisional application is based on Japanese Patent Application No. 2023-152119 filed on Sep. 20, 2023 with the Japan Patent Office, the entire contents of which are hereby incorporated by reference.

### BACKGROUND

### Field

The present disclosure relates to a method of manufacturing a power storage cell.

### Description of the Background Art

Japanese Patent Laying-Open No. 11-273743 discloses a conventional cylindrical non-aqueous electrolyte solution secondary battery. In the cylindrical non-aqueous electrolyte solution secondary battery, a spirally wound electrode assembly is housed in a cylindrical battery can together with a non-aqueous electrolyte solution. The spirally wound electrode assembly is formed by spirally winding a strip-shaped negative electrode and a strip-shaped positive electrode with a separator interposed therebetween, and fixing the winding end portion using an adhesive tape.

### SUMMARY

In the secondary battery (power storage cell) disclosed in Japanese Patent Laying-Open No. 11-273743, the wound electrode assembly expands and shrinks during charging and discharging. During expansion and shrinkage, relative displacement of the winding end portion fixed by the adhesive tape, with respect to the main body of the wound electrode assembly, is suppressed. Accordingly, stress is concentrated on the winding end portion of the wound electrode assembly.

It is an object to provide a method of manufacturing a power storage cell that enables manufacture of a power storage cell in which stress concentration on the winding end portion of the wound electrode assembly is alleviated when the wound electrode assembly expands and shrinks.

A method of manufacturing a power storage cell based on the present disclosure includes: forming a wound electrode assembly by winding a positive electrode, a negative electrode, and a separator; fixing a winding end portion, in a winding direction, of the wound electrode assembly, by a fixing member; housing, in a cell case, the wound electrode assembly having the winding end portion fixed by the fixing member; injecting an electrolyte solution in the cell case; and releasing fixing of the winding end portion by the fixing member, after the wound electrode assembly is housed in the cell case and the electrolyte solution is injected in the cell case.

When the power storage cell is charged and discharges, the wound electrode assembly expands and shrinks. The above-described configuration releases fixing by the fixing member, and therefore, a power storage cell can be manufactured in which stress concentration on the winding end portion of the wound electrode assembly is alleviated when the wound electrode assembly expands and shrinks.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic cross-sectional view showing an example of a power storage cell according to the present embodiment.

FIG. 2 is a flowchart showing a method of manufacturing the power storage cell according to the present embodiment.

FIG. 3 is a schematic perspective view showing a wound electrode assembly in which a winding end portion is fixed by a fixing member.

FIG. 4 is a schematic cross-sectional view showing a wound electrode assembly in which a winding end portion is fixed by a fixing member.

FIG. 5 is a schematic cross-sectional view showing the wound electrode assembly and a cell case immediately after being housed in the cell case.

### DESCRIPTION OF THE EMBODIMENTS

Hereinafter, a method of manufacturing a power storage cell according to an embodiment of the present disclosure will be described with reference to the drawings. The same or corresponding parts in the drawings are denoted by the same reference numerals, and the description thereof will not be repeated.

### (Power Storage Cell)

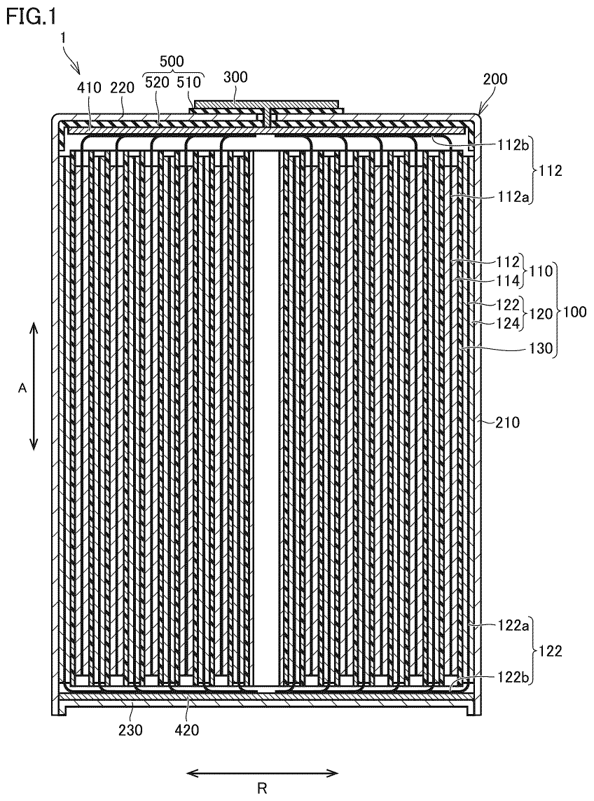

First, a power storage cell that can be manufactured by a method of manufacturing a power storage cell according to an embodiment of the present disclosure will be described. FIG. 1 is a schematic cross-sectional view showing an example of a power storage cell according to the present embodiment. The power storage cell 1 shown in FIG. 1 can be applied to any application. The power storage cell 1 may be used, for example, as a power supply of a vehicle.

As illustrated in FIG. 1, the power storage cell 1 includes a cell case 200, a wound electrode assembly 100, and an electrolyte solution (not illustrated). The power storage cell 1 may further include, for example, an external terminal 300, a positive electrode current collector plate 410, a negative electrode current collector plate 420, an insulating member 500, and the like.

The wound electrode assembly 100 is formed by winding an electrode and a separator 130. The “electrode” is a generic term for positive electrode 110 and negative electrode 120. That is, the wound electrode assembly 100 includes a positive electrode 110, a negative electrode 120, and a separator 130. Each of the positive electrode 110, the negative electrode 120, and the separator 130 has a belt shape. Each of the positive electrode 110, the negative electrode 120, and the separator 130 has a sheet shape. For example, a stack may be formed by stacking the positive electrode 110, the separator 130, and the negative electrode 120 in this order. The wound electrode assembly 100 may be formed by spirally winding the stack. The wound electrode assembly 100 may be formed in a flat shape, for example.

The positive electrode 110 includes a positive electrode current collector foil 112 and a positive electrode active material layer 114. The positive electrode current collector foil 112 may contain, for example, Al or the like.

The positive electrode current collector foil 112 includes a first region 112a and a second region 112b. The positive electrode active material layer 114 is disposed in the first region 112a. The positive electrode active material layer 114 may contain, for example, a lithium-nickel composite oxide or the like.

The second region 112b is adjacent to the first region 112a. The second region 112b is disposed at an end portion in the axial direction. The “axial direction” is the direction A in FIG. 1. The second region 112b has a plurality of tabs. The plurality of tabs are separated in the winding direction of the wound electrode assembly 100. For example, a plurality of tabs may be welded to the second region 112b. For example, a part of the second region 112b may be processed into a tab. Each tab is bent inward in the radial direction. The “radial direction” is the direction R in FIG. 1 for example. The outer surface of each tab forms a generally flat surface. Each tab is connected to the positive electrode current collector plate 410. Each tab may be welded to the positive electrode current collector plate 410.

The negative electrode 120 includes a negative electrode current collector foil 122 and a negative electrode active material layer 124. The negative electrode current collector foil 122 may contain, for example, Cu, Ni, or the like.

The negative electrode current collector foil 122 includes a first region 122a and a second region 122b. The negative electrode active material layer 124 is disposed in the first region 122a. The negative electrode active material layer 124 may contain, for example, graphite, Si, SiO, or the like.

The second region 122b is adjacent to the first region 122a. The second region 122b is disposed at an end portion in the axial direction. The second region 122b has a plurality of tabs. The plurality of tabs are separated in the winding direction of the wound electrode assembly 100. Each tab is bent inward in the radial direction. The outer surface of each tab forms a generally flat surface. Each tab is connected to the negative electrode current collector plate 420. Each tab may be welded to the negative electrode current collector plate 420. Each tab may be welded to a bottom wall 230 of the cell case 200, which will be described later.

The separator 130 has electrical insulation properties. Separator 130 electrically separates positive electrode 110 from negative electrode 120. In the radial direction, the separator 130 is disposed between the positive electrode 110 and the negative electrode 120. The separator 130 is porous. The electrolyte solution may permeate the separator 130. The separator 130 may include, for example, a porous resin film or the like.

The outermost layer of the wound electrode assembly 100 may be an electrode or a separator 130. The “outermost layer” refers to a member of the positive electrode 110, the negative electrode 120, and the separator 130 that is located on the outermost side in the radial direction at the winding end portion of the wound electrode assembly 100 as described later. In the present embodiment, the outermost layer of the wound electrode assembly 100 is an electrode. That is, the outermost layer of the wound electrode assembly 100 is the positive electrode 110 or the negative electrode 120. Specifically, the outermost layer of the wound electrode assembly 100 is the negative electrode 120. More specifically, the outermost layer is the negative electrode active material layer 124, but may be the negative electrode current collector foil 122.

The outermost layer is in contact with the cell case 200. Specifically, the outermost layer is in close contact with a peripheral wall 210 as described later. The portion of the cell case 200 that contacts the outermost layer (i.e., the peripheral wall 210) is made of an electrically conductive material.

The electrolyte solution is a liquid electrolyte. The electrolyte solution includes a solute and a solvent. The electrolyte solution may further contain an optional additive. The solute includes a supporting electrolyte. The solute may include, for example, at least one selected from the group consisting of LiPF₆, LiBF₄, LiN(SO₂F)₂, LiN(SO₂CF₃)₂, LiB(C₂O₄)₂, LiPO₂F₂, and FSO₃Li. The concentration of the solute may be, for example, 0.5 to 2 mol/L.

In the present embodiment, the solvent can dissolve an adhesive component of a fixing member as described later. The solvent may contain any component as long as it can dissolve the adhesive component. The solvent may include, for example, a carbonate-based solvent. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), and fluoroethylene carbonate (FEC).

As shown in FIG. 1, the cell case 200 accommodates the wound electrode assembly 100, a fixing member 140, and the electrolyte solution. The cell case 200 may have any form. The cell case 200 may be a cylindrical shape, a prismatic shape or a laminate shape. The laminate cell case 200 is formed by a metal foil laminate film.

The cell case 200 may be made of metal, for example. The cell case 200 may include, for example, a peripheral wall 210, a top wall 220, and a bottom wall 230. The peripheral wall 210 may have a cylindrical outer shape. The peripheral wall 210 surrounds the outer peripheral surface of the wound electrode assembly 100. In the present embodiment, the peripheral wall 210 is in close contact with the outermost layer of the wound electrode assembly 100. The peripheral wall 210 is formed of a metal such as aluminum or an aluminum alloy, copper, or stainless steel.

The top wall 220 is connected to an axial end portion of the peripheral wall 210. For example, a through hole for connection to the external terminal 300 may be formed in a central portion of the top wall 220. The bottom wall 230 faces the top wall 220 in the axial direction. The bottom wall 230 is connected to an axial end portion of the peripheral wall 210. The peripheral wall 210 and the bottom wall 230 are in contact with the negative electrode current collector plate 420. Any one of the peripheral wall 210 and the bottom wall 230 may be in contact with the negative electrode current collector plate 420. The peripheral wall 210 and the bottom wall 230 may be electrically insulated from each other through an insulating member.

At least one of the top wall 220 and the bottom wall 230 may be provided with a liquid injection port (not shown) for injecting the electrolyte solution into the cell case 200.

The external terminal 300 is disposed on the outer surface of the top wall 220. In the present embodiment, the external terminal 300 has positive polarity. The cell case 200 has negative polarity. When the peripheral wall 210 and the bottom wall 230 are electrically insulated from each other, only the bottom wall 230 may have negative polarity, or only the peripheral wall 210 and the top wall 220 of the cell case 200 may have negative polarity.

The insulating member 500 electrically isolates the external terminal 300 from the cell case 200. The insulating member 500 may include, for example, a first insulating portion 510 and a second insulating portion 520. The first insulating portion 510 is interposed between the external terminal 300 and the top wall 220. In the cell case 200, the second insulating portion 520 is interposed between the positive electrode current collector plate 410 and the cell case 200.

### (Method of Manufacturing Power Storage Cell)

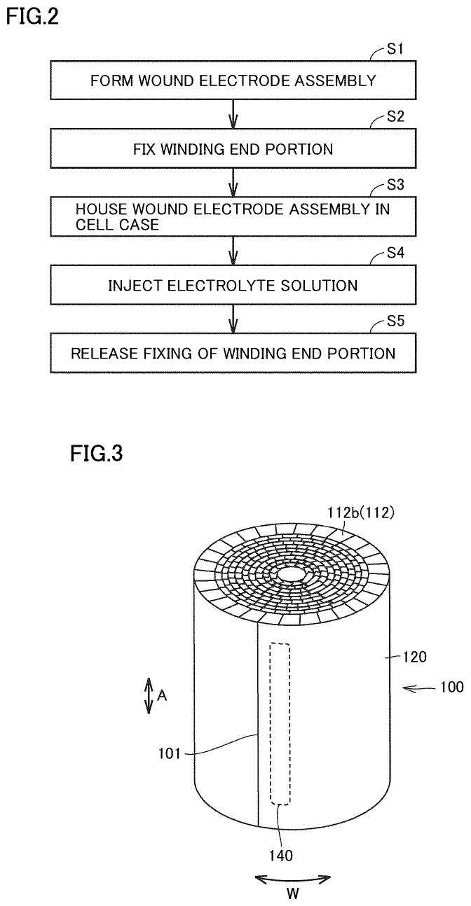

Next, a method of manufacturing a power storage cell according to an embodiment of the present disclosure will be described. FIG. 2 is a flowchart showing a method of manufacturing the power storage cell according to the present embodiment.

As shown in FIG. 2, the method of manufacturing the power storage cell according to the present embodiment includes a step S1 of forming a wound electrode assembly, a step S2 of fixing a winding end portion, a step S3 of housing the wound electrode assembly in a cell case, a step S4 of injecting an electrolyte solution, and a step S5 of releasing the fixing of the winding end portion.

In step S1, the positive electrode 110, the negative electrode 120, and the separator 130 are wound to form the wound electrode assembly 100 (see FIG. 1). The radial dimension of the wound electrode assembly 100 formed at the time of step S1 is smaller than the radial dimension of the wound electrode assembly 100 shown in FIG. 1.

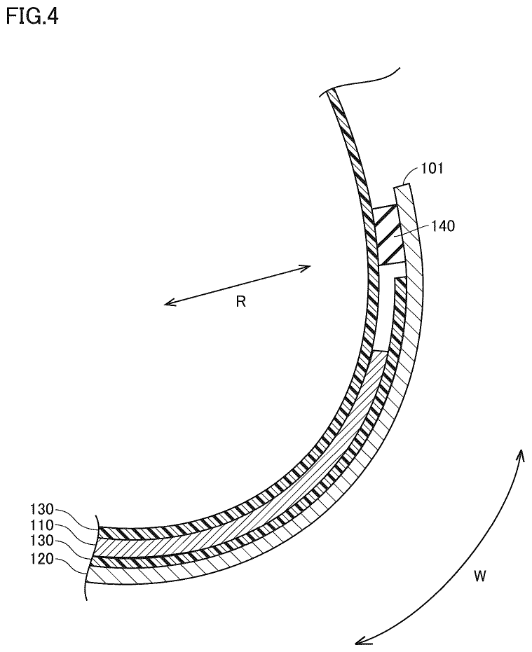

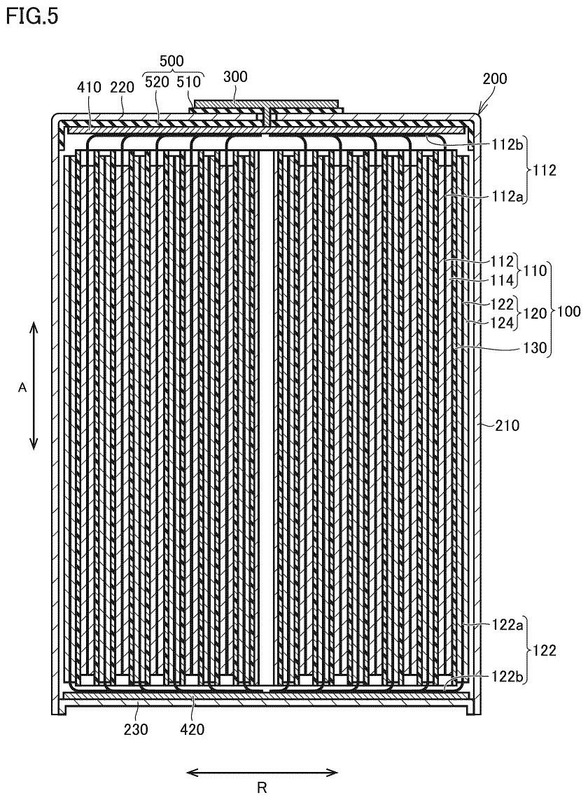

FIG. 3 is a schematic perspective view showing a wound electrode assembly in which a winding end portion is fixed by a fixing member. FIG. 4 is a schematic cross-sectional view showing a wound electrode assembly in which a winding end portion is fixed by a fixing member. As shown in FIGS. 3 and 4, in step S2, the winding end portion 101 in the winding direction of the wound electrode assembly 100 is fixed by the fixing member 140. FIGS. 3 and 4 illustrate a winding end portion 101 of the wound electrode assembly 100.

The “winding direction” is the W direction shown in FIGS. 3 and 4. The fixing member 140 fixes the winding end portion 101. The fixing member 140 is provided on the inner peripheral side of the winding end portion 101 in the radial direction. Part or all of the fixing member 140 may be provided on the inner peripheral side of the winding end portion 101 in the radial direction. The fixing member 140 may be provided on the outer peripheral side of the winding end portion 101 in the radial direction. The fixing member 140 may be provided so as to straddle an end edge of the winding end portion 101 in the winding direction.

The fixing member 140 is provided on the inner peripheral side of the outermost layer (specifically, the negative electrode 120) of the wound electrode assembly 100 in the radial direction. Part or all of the fixing member 140 may be provided on the inner peripheral side of the outermost layer in the radial direction. The fixing member 140 may be provided on the outer peripheral side of the outermost layer in the radial direction. The fixing member 140 may be provided so as to straddle an end edge of the outermost layer in the winding direction. The fixing member 140 may be provided in one region of the winding end portion 101, or a plurality of fixing members 140 may be provided in each of a plurality of regions of the winding end portion 101. In the winding direction, the fixing member 140 may have a width of, for example, 1 to 10 mm or 3 to 7 mm.

The fixing member 140 may be a hot-melt adhesive. In step S2, the hot-melt adhesive is melted or softened by heating and thermally fused to both the outermost layer of the winding end portion 101 and the layer constituting the inner peripheral side thereof. Then, the winding end portion 101 is fixed by being solidified by subsequent cooling.

Examples of the hot-melt adhesive include a rubber-based hot-melt adhesive, a polyester-based hot-melt adhesive, a polyolefin-based hot-melt adhesive, an ethylene vinyl acetate resin-based hot-melt adhesive, a polyamide resin hot-melt adhesive, and a polyurethane resin hot-melt adhesive. The softening temperature (ring ball method) of the hot-melt adhesive is, for example, 50° C. or more and 200° C. In some embodiments, the softening temperature of the hot-melt adhesive is as low as possible, for example, less than 100° C. or 80° C. or less. In some embodiments, the softening temperature of the hot-melt adhesive is about 60° C.

The fixing member 140 may be formed of a material that has solubility in the electrolyte solution. More specifically, the outer surface of the fixing member 140 may be formed of a material that has solubility in the electrolyte solution.

When the fixing member 140 is formed of a material that has solubility in the electrolyte solution, the fixing member 140 or its outer surface includes an adhesive component. The adhesive component has solubility in the electrolyte solution. The adhesive component may contain any component as long as it can be dissolved in the electrolyte solution. The adhesive component may be, for example, non-self-supporting. When the fixing member 140 further includes a base material, the non-self-supporting adhesive component may be supported by the base material. The adhesive component may be applied to the surface of the base material. The base material may be impregnated with the adhesive component. The adhesive component may include, for example, at least one selected from the group consisting of an acrylic-based adhesive, a silicone-based adhesive, a urethane-based adhesive, and a rubber-based adhesive.

The adhesive component may be self-supporting. Self-supporting adhesive components may be used without a base material. The adhesive component may include at least one selected from the group consisting of a vinyl acetate resin-based emulsion adhesive, an acrylic resin-based emulsion adhesive, a vinyl acetate resin-based solvent adhesive, an acrylic resin-based solvent adhesive, a vinyl chloride resin-based solvent adhesive, a chloroprene rubber-based solvent adhesive, a chloroprene rubber solvent-based mastic adhesive, a nitrile rubber-based solvent adhesive, a urethane resin-based adhesive, an epoxy resin-based adhesive, a modified silicone resin-based adhesive, an epoxy modified silicone resin-based adhesive, a starch-based adhesive, a polymer cement mortar, an epoxy resin mortar, and a silylated urethane resin-based adhesive, for example.

FIG. 5 is a schematic cross-sectional view showing the wound electrode assembly and the cell case immediately after being housed in the cell case. As shown in FIG. 5, in step S3, the wound electrode assembly 100 having the winding end portion 101 fixed by the fixing member 140 is housed in the cell case 200. Immediately after step S3, the wound electrode assembly 100 may not be in contact with the peripheral wall 210 of the cell case 200.

In step S4, the electrolyte solution is injected into the cell case 200. Specifically, the electrolyte solution may be injected from an injection port formed in the top wall 220 or the bottom wall 230.

In step S5, the fixing of the winding end portion 101 by the fixing member 140 is released after step S3 of housing the wound electrode assembly 100 in the cell case 200 and step S4 of injecting the electrolyte solution into the cell case 200.

When the fixing member 140 is a hot-melt adhesive, the fixing of the winding end portion 101 by the fixing member 140 may be released by heating the electrolyte solution injected into the cell case 200 in step S5. The heating method may be a method of heating the power storage cell 1 from the outside or a method of heating the wound electrode assembly 100 by charging and discharging the power storage cell 1. By the heating, the hot-melt adhesive is melted again and softened. As a result, the winding end portion 101 is separated from the inner peripheral portion of the wound electrode assembly 100 again. The fixing of the winding end portion 101 is released.

When the fixing member 140 is formed of a material having solubility in the electrolyte solution, the fixing of the winding end portion 101 by the fixing member 140 may be released by treating the electrolyte solution injected into the cell case 200 so that the fixing member 140 dissolves.

When the fixing member 140 or a part thereof is formed of a material having solubility, a specific method of the above-described treatment may be appropriately selected according to the solubility of the adhesive member constituting the fixing member 140 or a part thereof in the solvent of the electrolyte solution. For example, the above-described treatment may be a method of allowing the power storage cell 1 to stand at room temperature for a predetermined time, a method of heating the power storage cell 1 from the outside, or a method of causing the wound electrode assembly 100 to generate heat by charging and discharging the power storage cell 1.

In addition, all of the adhesive components may be dissolved. A part of the adhesive component may be dissolved. By dissolving at least a part of the adhesive component, the fixing force may be reduced. By dissolving the adhesive component, the fixing of the winding end portion 101 may be completely released. The fixing of the winding end portion 101 may be partially released.

In step S5, the fixing of the winding end portion 101 by the fixing member 140 is released to bring the outermost layer of the wound electrode assembly into contact with the cell case 200 (see FIGS. 1 and 5). When the fixing is released, the winding of the wound electrode assembly 100 is loosened. As a result, a portion of the wound electrode assembly 100 including the winding end portion 101 facing the peripheral wall 210 is displaced outward in the radial direction. The outermost layer of the wound electrode assembly 100 is in close contact with the peripheral wall 210 of the cell case 200.

As described above, the method of manufacturing a power storage cell according to one embodiment of the present disclosure includes forming the wound electrode assembly 100 by winding the positive electrode 110, the negative electrode 120, and the separator 130 (S1), fixing the winding end portion 101, in the winding direction, of the wound electrode assembly 100, by the fixing member 140 (S2), housing, in the cell case 200, the wound electrode assembly 100 having the winding end portion 101 fixed by the fixing member 140 (S3), injecting the electrolyte solution in the cell case 200 (S4), and releasing fixing of the winding end portion 101 by the fixing member 140, after the wound electrode assembly 100 is housed in the cell case 200 and the electrolyte solution is injected in the cell case 200 (S5).

When the power storage cell 1 is charged and discharged, the wound electrode assembly 100 expands and shrinks. According to the above configuration, since the fixing by the fixing member 140 is released at the time of manufacturing, it is possible to manufacture the power storage cell 1 in which concentration of stress on the winding end portion of the wound electrode assembly 100 is alleviated when the wound electrode assembly 100 expands and shrinks.

Further, in the present embodiment, the fixing member 140 may be a hot-melt adhesive. Then, fixing of the winding end portion 101 by the fixing member 140 may be released by heating the electrolyte solution injected in the cell case 200 (S5).

According to the above configuration, it is possible to suppress a change in the property of the electrolyte solution due to dissolution of the fixing member 140 in the electrolyte solution.

Further, in the present embodiment, the fixing member 140 may be formed of a material having solubility in the electrolyte solution. Then, fixing of the winding end portion 101 by the fixing member 140 may be released by performing a treatment in a manner that causes the fixing member 140 to be dissolved in the electrolyte solution injected in the cell case 200 (S5).

According to the above configuration, since the fixing member 140 is dissolved in the electrolyte solution, the total volume of the members accommodated in the cell case 200 is reduced by the volume of the fixing member 140 before being dissolved. Accordingly, when the wound electrode assembly 100 expands, concentration of stress on a portion of the wound electrode assembly 100 and the cell case 200 can be further alleviated.

Further, in the present embodiment, the outermost layer of the wound electrode assembly 100 is the positive electrode 110 or the negative electrode 120. Then, the outermost layer is brought into contact with the cell case 200 by releasing fixing of the winding end portion 101 by the fixing member 140 (S5).

According to the above configuration, heat generated from the wound electrode assembly 100 is easily transmitted to the cell case 200 via the outermost layer. Thus, the heat can be effectively released to the outside of the power storage cell 1.

Further, in the present embodiment, a portion of the cell case 200 that is brought into contact with the outermost layer is made of an electrically conductive material.

The electrically conductive material has relatively high thermal conductivity. Therefore, according to the above configuration, the heat generated from the wound electrode assembly 100 is more easily transmitted to the cell case 200 via the outermost layer. Thus, the heat can be released more effectively to the outside of the power storage cell 1.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method of manufacturing a power storage cell, comprising:
forming a wound electrode assembly by winding a positive electrode, a negative electrode, and a separator;
fixing a winding end portion, in a winding direction, of the wound electrode assembly, by a fixing member;
housing, in a cell case, the wound electrode assembly having the winding end portion fixed by the fixing member;
injecting an electrolyte solution in the cell case; and
releasing fixing of the winding end portion by the fixing member, after the wound electrode assembly is housed in the cell case and the electrolyte solution is injected in the cell case.

2. The method of manufacturing a power storage cell according to claim 1, wherein
the fixing member is a hot-melt adhesive, and
fixing of the winding end portion by the fixing member is released by heating the electrolyte solution injected in the cell case.

3. The method of manufacturing a power storage cell according to claim 1, wherein
the fixing member is formed of a material having solubility in the electrolyte solution, and
fixing of the winding end portion by the fixing member is released by performing a treatment in a manner that causes the fixing member to be dissolved in the electrolyte solution injected in the cell case.

4. The method of manufacturing a power storage cell according to claim 1, wherein
an outermost layer of the wound electrode assembly is the positive electrode or the negative electrode, and
the outermost layer is brought into contact with the cell case by releasing fixing of the winding end portion by the fixing member.

5. The method of manufacturing a power storage cell according to claim 4, wherein a portion of the cell case that is brought into contact with the outermost layer is made of an electrically conductive material.
